(19) United States
(12) Patent Application Publication
(10) Pub. No.: US 2026/0336617 A1
(43) Pub. Date: Oct. 29, 2026

(54) VEHICLE AND METHOD FOR CONTROLLING THE SAME

(71) Applicants: Hyundai Motor Company, Seoul (KR); Kia Corporation, Seoul (KR)

(72) Inventor: Jeong Ki HONG, Hwaseong-Si (KR)

(21) Appl. No.: 19/392,724

(22) Filed: Nov. 18, 2025

(30) Foreign Application Priority Data
Apr. 29, 2025 (KR) 10-2025-0056210

(51) Int. Cl. B60W 30/14; B60W 60/00

(52) U.S. Cl. CPC B60W 30/146; B60W 60/001; B60W 2510/1005; B60W 2520/10; B60W 2552/15; B60W 2552/30; B60W 2552/35; B60W 2554/4042; B60W 2554/406; B60W 2554/802; B60W 2555/60; B60W 2556/35; B60W 2556/45; B60W 2720/10

(57) ABSTRACT

A vehicle and a control method thereof are disclosed. An autonomous vehicle control device according to an example of the present disclosure comprises: a memory; and one or more processors coupled to the memory, wherein the one or more processors may be configured to: collect first data associated with surrounding objects from a Smart Cruise Control (SCC) system based on sensor information; collect second data associated with road events from a Navigation-based Smart Cruise Control (NSCC) system based on navigation information; determine a target speed of the autonomous vehicle based on the first data and the second data; and control driving of the autonomous vehicle in accordance with the determined target speed.

### CROSS-REFERENCE TO RELATED APPLICATION

This application claims the benefit of priority to Korean Patent Application No. 10-2025-0056210, filed in the Korean Intellectual Property Office on Apr. 29, 2025, the disclosure of which is incorporated herein by reference in its entirety.

### FIELD OF TECHNOLOGY

Various examples of the present disclosure relate to an autonomous vehicle and a method for controlling an autonomous vehicle.

### BACKGROUND

The matters described in this Background section are only for enhancement of understanding of the background of the disclosure, and should not be taken as acknowledgment that they correspond to prior art already known to those skilled in the art.

An autonomous driving system may recognize a front object using sensor data or identify an event on a road using a navigation system, and may automatically control a speed of a vehicle.

However, such systems may independently determine the speed without considering interrelations between each control system, so that the autonomous vehicle may frequently experience repeated acceleration and deceleration, which may cause a problem of reduced fuel efficiency.

### SUMMARY

An object of the present disclosure, which has been devised to solve the aforementioned problems, is to reduce or minimize unnecessary acceleration and deceleration of an autonomous vehicle by integrally considering information obtained from a sensor-based Smart Cruise Control (SCC) system and a navigation-based Smart Cruise Control (NSCC) system.

The objects of the present disclosure are not limited to the objects mentioned above, and other unmentioned objects will be clearly understood by those of ordinary skill in the art from the following description.

According to the present disclosure, an apparatus of a vehicle may comprise a communication interface configured to receive first data from a Smart Cruise Control (SCC) system based on sensor information and second data from a Navigation-based Smart Cruise Control (NSCC) system based on navigation information. The apparatus may further comprise a processor and a memory storing at least one instruction that, when executed by the processor, may cause the apparatus to obtain, via the communication interface, the first data associated with at least one object in a surrounding environment of the vehicle; obtain, via the communication interface, the second data associated with at least one event on a road on which the vehicle is traveling; output, based on the first data and the second data, a signal indicating a target speed of the vehicle; and control, based on the signal, autonomous driving of the vehicle. The target speed may be determined based on third data associated with a state of the vehicle and in combination with the first data obtained from the SCC system and the second data obtained from the NSCC system. The SCC system is configured to obtain at least one of a distance between the vehicle and the at least one object, a speed of the at least one object, or an acceleration of the at least one object. The NSCC system is configured to obtain at least one of a curvature of the road, a speed bump on the road, a gradient of the road, a traffic congestion section on the road, speed limit information on the road, or traffic signal information on the road. The first data and the second data may be fused by comparing a set speed of the SCC system with a required speed of the NSCC system and recognizing continuous deceleration events within a predetermined distance or time. The third data may comprise at least one of a speed of the vehicle, a gear state of the vehicle, or a revolutions per minute (RPM) of the vehicle. The first data may comprise at least one of a distance between the vehicle and the at least one object, a speed of the at least one object, or an acceleration of the at least one object. The second data may comprise at least one of a curvature of the road, a speed bump on the road, a gradient of the road, a traffic congestion section on the road, speed limit information on the road, or traffic signal information on the road. The at least one object may comprise objects located in front of or behind the vehicle. The at least one instruction, when executed by the processor, may be configured to cause the apparatus to control driving of the vehicle based on the target speed, a current speed of the vehicle being less than a first speed that is determined based on the first data, the current speed of the vehicle being less than a second speed that is determined based on the second data, and a distance from the vehicle to a location associated with the at least one event being less than a predetermined distance. The at least one instruction, when executed by the processor, may be configured to cause the apparatus to determine the target speed based on a lower speed of the first speed and the second speed, wherein the target speed may be at or below the lower speed for a section of the road leading to the at least one event. The at least one instruction, when executed by the processor, may be configured to cause the apparatus to determine the target speed to be at or below the lower speed based on third data associated with a state of the vehicle. The at least one instruction, when executed by the processor, may be configured to cause the apparatus to determine the target speed differently based on a remaining distance to a location associated with the at least one event. According to the present disclosure, a method performed by an apparatus of a vehicle may comprise obtaining, via a communication interface of the apparatus, first data associated with at least one object in a surrounding environment of the vehicle from a Smart Cruise Control (SCC) system based on sensor information; obtaining, via the communication interface, second data associated with at least one event on a road on which the vehicle is traveling from a Navigation-based Smart Cruise Control (NSCC) system based on navigation information; outputting, based on the first data and the second data, a signal indicating a target speed of the vehicle; and controlling, based on the signal, autonomous driving of the vehicle. The method may further comprise determining the target speed based on the first data, the second data, and third data, wherein the third data may be associated with a state of the vehicle. According to the present disclosure, a vehicle may comprise a sensor configured to obtain first data associated with at least one object in a surrounding environment of the vehicle, wherein the first data may comprise at least one of a distance from the vehicle to the at least one object, a speed of the at least one object, or an acceleration of the at least one object. The vehicle may further comprise a navigation system configured to provide second data associated with at least one event on a road on which the vehicle is traveling, wherein the at least one event may comprise at least one of a speed limit section on the road, a speed bump on the road, a traffic congestion section on the road, or a curvature of the road; a driving control circuit configured to control autonomous driving of the vehicle; and a processor circuit configured to obtain, via the sensor, the first data associated with the at least one object in the surrounding environment of the vehicle; obtain, via the navigation system, the second data associated with the at least one event on the road on which the vehicle is traveling; output a signal indicating a target speed of the vehicle, wherein the target speed may be determined based on the first data and the second data such that the target speed reduces repeated acceleration or deceleration of the vehicle; and control, via the driving control circuit and based on the signal, autonomous driving of the vehicle. The processor circuit may be configured to determine the target speed as a lesser of a first speed determined based on the first data and a second speed determined based on the second data. The processor circuit may be configured to, based on deceleration events occurring one after another within a predetermined distance or time, determine the target speed to maintain a current decelerated state without an intermediate acceleration. The processor circuit may be configured to, based on a congestion state of a rear section of the vehicle detected from the first data, adjust a rate at which the vehicle accelerates toward the target speed, output a second signal indicating a target lane for the vehicle, wherein the target lane may be determined based on the first data and the second data such that the target lane reduces repeated acceleration or deceleration of the vehicle, and control the autonomous driving of the vehicle further based on the second signal.

The effects of the present disclosure are not limited to the effects mentioned above, and other unmentioned effects will be clearly understood by those of ordinary skill in the art from the following description.

### BRIEF DESCRIPTION OF THE DRAWINGS

FIG. 1 shows an example of an autonomous vehicle.

FIG. 2 shows an example of a speed control operation of an autonomous vehicle.

FIG. 3 shows an example of a speed control operation of an autonomous vehicle.

FIGS. 4, 5 and 6 show examples of specific driving situations.

FIG. 7 shows an example computing system.

### DETAILED DESCRIPTION

Hereinafter, one or more example examples of the present disclosure will be described in detail with reference to the accompanying drawings.

However, the technical idea of the present disclosure is not limited to the example examples as described herein but may be implemented in various different forms, and within the scope of the technical idea of the present disclosure, one or more among components in the example examples may be used by being selectively combined and substituted.

Further, unless specifically defined and described, terms used in the example examples of the present disclosure (including technical and scientific terms) may be interpreted as meanings which are generally understood by those skilled in the art to which the present disclosure pertains, and commonly used terms such as terms defined in the dictionary may be interpreted in consideration of the contextual meaning of the related art.

The terms used in the example examples of the present disclosure are for the purpose of describing the example examples only and are not intended to limit the disclosure.

In the present specification, the singular forms may include the plural forms unless the context clearly dictates otherwise. For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as "A, B, or C", "at least one of A, B, and C", "at least one of A, B, or C", etc. as used herein may mean each listed item or all possible combinations of the listed items. For example, "at least one of A or B" may refer to (1) at least one A; (2) at least one B; or (3) at least one A and at least one B.

In addition, in describing a component of example examples of the present disclosure, terms such as first, second, A, B, (a), (b), etc., may be used.

These terms are only for distinguishing the component from other components, and the essence, sequence, or order of the component is not limited by the terms.

In addition, when a component is described as being “linked,” “coupled,” or “connected” to another component, the component is not only directly linked, coupled, or connected to another component, but also “linked,” “coupled,” or “connected” to another component with still another component disposed between the component and the other component.

Further, when a component is described as being formed or disposed “on (above) or under (below)” another component, the term “on (above) or under (below)” includes not only situations when two components are in direct contact with each other, but also situations when one or more of other components are formed or disposed between the two components. Further, when a component is described as being “on (above) or below (under),” the description may also include the meanings of an upward direction and a downward direction relative to one component.

The term "autonomous driving system" or "driver control assistance system" as used in this document, refers to hardware and software capable of assisting the driver in continuously controlling the longitudinal and lateral movements of the vehicle. This driver control assistance system may be referred to as the “system” in this document.

The term "feature" as used in this document, may refer to a specific function of the system that provides assistance to the driver under defined traffic scenarios, conditions, and system boundaries.

The term "dynamic control" as used in this document, may refer to the real-time performance of operational and tactical functions required to move the vehicle. This may include control of the vehicle’s lateral and longitudinal movements, monitoring of the road environment, responding to events in the road traffic environment, operational planning, and signal delivery.

The term "system boundaries" as used in this document, may refer to verifiable or measurable limits or conditions set by the manufacturer, up to or within the range of the conditions that affect the ability of the system or its features to operate as intended and to provide assistance to the driver.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be dynamically activated or adjusted based on a fuel-efficient target speed control integrating sensor-based Smart Cruise Control (SCC) data and navigation-based Smart Cruise Control (NSCC) road-event data (e.g., speed limit sections, speed bumps, traffic congestion sections, road curvature, or construction zones, etc.). For example, when SCC data indicate a forward vehicle decelerating to 40 km/h and NSCC data show a speed bump within 300 m, the system may automatically lower the autonomous driving level to prompt increased driver attentiveness or suppress unnecessary intermediate acceleration until the event is passed. Conversely, when SCC and NSCC data indicate a clear road for more than 1,500 m, the system may automatically restore a higher autonomous driving level and resume smooth acceleration toward the user-set speed.

Based on such data, an operation of the vehicle may be controlled. The vehicle control may include various operational controls associated with the vehicle such as autonomous driving control (e.g., selecting an appropriate autonomous driving classification or level for a given road section), sensor control (e.g., increasing the sampling rate of LIDAR and RADAR near upcoming events while reducing non-critical sensors to save power), braking control and braking time control (e.g., pre-emptively activating regenerative braking before an NSCC-detected downhill segment), acceleration control and acceleration-change-rate control (e.g., applying slow acceleration when a speed bump is detected 500 m ahead), alarm-timing control (e.g., warning the driver earlier when SCC data show a sudden deceleration of a forward vehicle plus an upcoming NSCC event), and forward-collision warning-time control (e.g., dynamically adjusting warning thresholds according to the combined SCC/NSCC-based target speed).

One or more auxiliary devices may also be dynamically controlled based on a fuel-efficient target speed control that integrates sensor-based Smart Cruise Control (SCC) data and navigation-based Smart Cruise Control (NSCC) road-event data (e.g., speed limit sections, speed bumps, traffic congestion, or steep downhill grades, etc.). For example, when SCC data indicate a forward vehicle decelerating and NSCC data show a downhill road segment with an upcoming speed limit of 30 km/h, the processor may pre-emptively activate an engine brake, exhaust brake, or regenerative brake to maintain the fuel-efficient target speed without excessive service braking. Conversely, if SCC and NSCC data indicate a clear flat road with no events within 1,500 m, the system may deactivate or reduce the auxiliary braking functions to allow smoother acceleration toward the user-set speed.

One or more communication devices (e.g., a modem, a network adapter, a radio transceiver, an antenna, etc.) capable of communicating via one or more wired or wireless communication protocols (such as Ethernet, Wi-Fi, near-field communication (NFC), Bluetooth, Long-Term Evolution (LTE), 5G New Radio (NR), vehicle-to-everything (V2X), etc.) may also be controlled based on SCC and NSCC data. For example, when NSCC data show an upcoming construction zone or high congestion area, the processor may automatically increase V2X transmission frequency to share target speed and position information with nearby vehicles or infrastructure, whereas when SCC and NSCC data show a clear road ahead, it may lower communication rates to save power.

Minimum risk maneuver (MRM) operation(s) may also be dynamically controlled based on a fuel-efficient target speed control that integrates sensor-based Smart Cruise Control (SCC) data and navigation-based Smart Cruise Control (NSCC) road-event data (e.g., speed limit sections, speed bumps, traffic congestion, or road curvature, etc.). A minimal risk maneuvering operation (e.g., a minimal risk maneuver, a minimum risk maneuver) may be a maneuvering operation of a vehicle in which the system uses the determined target speed and event data to minimize a risk of collision with surrounding vehicles and achieve a lowered (e.g., minimum) risk state while also avoiding unnecessary acceleration or deceleration.

A minimal risk maneuver may be an operation activated during autonomous driving of the vehicle when a driver is unable to respond to a request to intervene and when SCC and NSCC data indicate upcoming road events that require specific speed management (e.g., a forward vehicle braking hard combined with an NSCC-detected speed bump within 200 m). During the minimal risk maneuver, one or more processors of the vehicle may control a driving operation of the vehicle for a set period of time by, for example, automatically reducing speed to the fuel-efficient target speed, maintaining a steady decelerated state without intermediate acceleration, biasing the vehicle to the safest lateral position in the lane (e.g., away from roadside obstacles detected by sensors), and applying smooth braking or steering adjustments to reach a designated safe stop area (e.g., road shoulder, emergency lane, or a detected low-risk zone).

For example, if SCC data show a forward vehicle slowing sharply and NSCC data show a sharp curve or construction zone ahead, the processor may execute an MRM by gradually decelerating to a precomputed fuel-efficient target speed of 20 km/h, activating hazard lights, and guiding the vehicle to the rightmost lane or road shoulder until driver intervention resumes. Conversely, if the road ahead is clear beyond 1,000 m, the MRM may hold a moderate target speed (e.g., 50 km/h) and maintain lane center to conserve fuel while ensuring safety.

Biased driving operation(s) may also be dynamically controlled based on a fuel-efficient target speed control that integrates sensor-based Smart Cruise Control (SCC) data and navigation-based Smart Cruise Control (NSCC) road-event data (e.g., speed limit sections, speed bumps, traffic congestion, road curvature, or construction zones, etc.). A driving control apparatus may perform a biased driving control by adjusting the vehicle’s lateral position or lane offset in conjunction with the determined target speed to improve stability, comfort, and fuel efficiency. For example, when SCC data indicate a forward vehicle slowing and NSCC data indicate an upcoming speed bump within 300 m, the apparatus may reduce lateral maneuvers and keep the vehicle biased to one side of the lane to avoid rough pavement edges while maintaining the current decelerated state without unnecessary intermediate acceleration.

The driving control apparatus may identify a biased target lateral distance for biased driving control based on a combination of vehicle speed, road events, and predicted deceleration sequences derived from SCC and NSCC data. For example, a biased target lateral distance may comprise an intentionally adjusted lateral distance that the vehicle aims to maintain from a reference point (such as the center of a lane or another vehicle) during maneuvers like lane changes or when approaching a detected event. This adjustment may be made to improve the vehicle’s stability and safety under varying driving conditions while also reducing fuel consumption by minimizing repeated steering and speed corrections.

For example, during a lane change, when SCC data show a congested rear vehicle and NSCC data show a curve and speed limit section ahead, the driving control system may bias the lateral distance to keep a safer gap from adjacent vehicles, reduce steering effort, and coordinate with a lower target speed. Conversely, when SCC and NSCC data show a clear road ahead for more than 1,500 m, the system may reduce lateral biasing maneuvers and gradually return to the lane center as the vehicle accelerates toward the set speed.

One or more sensors may be dynamically managed or adjusted based on a fuel-efficient target speed control that integrates sensor-based Smart Cruise Control (SCC) data and navigation-based Smart Cruise Control (NSCC) road-event data (e.g., speed limit sections, speed bumps, traffic congestion, or road curvature, etc.). For example, when the system determines from SCC and NSCC data that a series of deceleration events is imminent (e.g., a forward vehicle slowing to 30 km/h plus a speed bump 300 m ahead), the processor may increase the sampling frequency of forward-looking sensors such as a camera, LIDAR, or RADAR to more precisely track the forward vehicle and road profile, while reducing the sampling of non-critical sensors to save power. Conversely, when SCC and NSCC data indicate a long clear road ahead (e.g., no events within 1,500 m), the processor may lower the refresh rate of certain sensors (e.g., rain sensor, blind-spot monitoring sensor) and maintain only essential sensors active to optimize energy usage. Such control may be applied to a wide range of sensors including IMU sensors, cameras, LIDAR, RADAR, blind-spot monitoring sensors, lane-departure warning sensors, parking sensors, light sensors, rain sensors, traction control sensors, anti-lock braking system sensors, tire pressure monitoring sensors, seatbelt sensors, airbag sensors, fuel sensors, emission sensors, throttle position sensors, as well as components such as an inverter, converter, motor controller, power distribution unit, high-voltage wiring and connectors, auxiliary power modules, and charging interfaces.

Controlling an autonomous driving function of the vehicle may be dynamically performed based on a fuel-efficient target speed control that integrates sensor-based Smart Cruise Control (SCC) data and navigation-based Smart Cruise Control (NSCC) road-event data (e.g., speed limit sections, speed bumps, traffic congestion sections, road curvature, or road construction, etc.). In particular, the vehicle control device may execute various driving controls to proactively reduce unnecessary acceleration and deceleration (e.g., automatically decelerating early when both SCC data show a forward vehicle slowing to 30 km/h and NSCC data indicate a speed bump 400 m ahead, maintaining the current decelerated state instead of re-accelerating; or, when SCC data show a clear road and NSCC data indicate no upcoming events within 1,500 m, gradually accelerating back to the user-set speed). Such control may be applied to a wide range of vehicle subsystems including acceleration/deceleration control, steering control, gear-shifting for fuel efficiency (e.g., downshifting to maintain optimal RPM when repeated deceleration events are detected), braking system control to hold a decelerated speed before an event, traction and stability control, cruise control, lane-keeping assist control, collision-avoidance system control, emergency-brake assistance control, traffic-sign recognition control, adaptive-headlight control, driver-warning control, or autonomous driving operational design domain (ODD) control.

An autonomous driving level and/or autonomous driving activation/deactivation may also be controlled based on a fuel-efficient target speed control that integrates sensor-based Smart Cruise Control (SCC) data and navigation-based Smart Cruise Control (NSCC) road-event data (e.g., speed limit sections, speed bumps, traffic congestion sections, etc.) described herein. A driving control apparatus may perform an autonomous driving level control (e.g., automatically adjusting an autonomous driving level, changing a required user attentiveness, or causing deactivation of the autonomous driving operation when the determined target speed indicates a continuous deceleration scenario). For example, when the processor determines from SCC and NSCC data that a series of deceleration events is imminent (e.g., forward vehicle slowing plus an upcoming speed bump within 500 m), it may keep the vehicle in a lower autonomous driving level or deactivate full autonomous driving to prompt the driver for increased attentiveness. By changing the required user attentiveness in such cases, the driver may be required to place his/her hands on the driving wheel more often (e.g., at least once in a threshold time period such as five seconds, 30 seconds, or one minute) or be required to look ahead more often (e.g., at least once in a threshold time period such as five seconds, 30 seconds, or one minute). By dynamically adjusting the autonomous driving level according to the fuel-efficient target speed control, one or more video contents or infotainment functions may not be displayed on a display of the vehicle to ensure the driver’s attention.

In the various flowcharts of the present disclosure, one or more operations may be omitted or performed in any other order. At least some of the example examples of the present disclosure may be performed at any particular or arbitrary point in each operation of the flowchart. Various flowcharts of the present disclosure may be performed by at least one of an autonomous driving control device (also referred to as a driving automation device or driving automation system), a processor 130, a control unit 100, an autonomous vehicle 10, or a computer program.

According to the present disclosure, an autonomous vehicle may be controlled in a manner that minimizes unnecessary acceleration and deceleration by integrally considering information obtained from a sensor-based Smart Cruise Control (SCC) system and a navigation-based Smart Cruise Control (NSCC) system. In particular, one or more processors of a control device may collect first data associated with surrounding objects from the SCC system based on sensor information, collect second data associated with road events from the NSCC system based on navigation information, determine a target speed of the autonomous vehicle based on the first data and the second data, and control driving of the autonomous vehicle in accordance with the determined target speed. By combining sensor information with navigation data, the autonomous vehicle may maintain safe distances, anticipate upcoming speed-change events, and reduce repeated acceleration and deceleration to provide smoother and more fuel-efficient driving.

Hereinafter, one or more example examples will be described in detail with reference to the accompanying drawings, but identical or corresponding components are denoted by the same reference numerals regardless of figure numbers, and redundant descriptions thereof will be omitted.

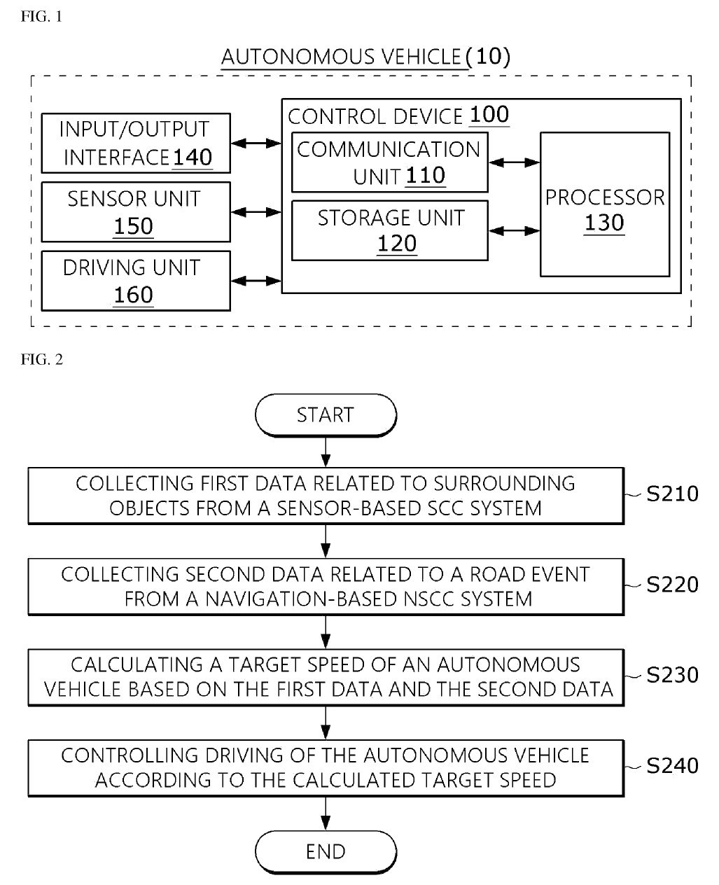

FIG. 1 shows an example of an autonomous vehicle 10 according to an example.

The autonomous vehicle 10 may include a control device 100, a communication unit 110, a storage unit 120, a processor 130, an input/output interface 140, a sensor unit 150, and a driving unit 160. Each of these components of FIG. 1 may be implemented inside the vehicle.

The autonomous vehicle 10 may be dynamically controlled in various driving situations through an autonomous driving system. For example, the autonomous driving system may provide both driving stability and convenience through longitudinal control (acceleration and deceleration) and lateral control (lane keeping and changing) of the autonomous vehicle 10. Such an autonomous driving system may monitor the driving environment through sensors and a control device, and process data in real time to adjust the position, driving speed, direction, and the like of the vehicle.

The control device 100 may be integrally formed with other internal components of the vehicle. Alternatively, the control device 100 may be implemented as a separate device and may communicate with the internal components of the vehicle via various connection means (e.g., a Controller Area Network (CAN) bus, a wireless network, a wired connection, or optical fiber, etc.). The control device 100 includes the communication unit 110, the storage unit 120, and the processor 130 to manage the longitudinal and lateral control of the vehicle, and may additionally include other components such as the input/output interface 140, the sensor unit 150, and the driving unit 160 to perform complex control functions according to a driving situation.

According to an example of the present disclosure, the control device 100 may receive, from the sensor unit 150, sensor information (e.g., first data) including a distance and a speed of a surrounding object. In addition, the control device 100 may receive, via the communication unit 110, road event information based on navigation information (e.g., second data). The control device 100 may determine a target speed of the autonomous vehicle 10 based on the first data and the second data using the processor 130. The processor 130 may control driving of the autonomous vehicle 10 in accordance with the determined target speed.

The control device 100 may store data collected from the sensor unit 150 during driving in the storage unit 120, and process the data in real time to control safety and convenience functions of the vehicle. For example, the control device 100 may perform overall control and management of the autonomous driving system, such as providing a notification in a situation in which driver intervention is required, based on data detected from the sensor unit 150.

According to an example of the present disclosure, the control device 100, via the processor 130, may determine the target speed differently based on a predetermined distance when a continuous deceleration event occurs, using sensor information (the first data) and navigation information (the second data).

The control device 100 may, based on various driver settings and driving conditions, display a vehicle control status or control a driving function by receiving a driver's input, through a user interface linked with a Human-Machine Interface (HMI).

The communication unit 110 may share data between systems by communicating with other control devices inside the vehicle, or may transmit and receive various information through a connection with an exterior of the vehicle. The communication unit 110 transmits control signals and data between internal components using various in-vehicle communication methods such as Controller Area Network (CAN) communication and Ethernet, and may link driving information and external data in real time through communication with a user terminal, other vehicles (V2V: Vehicle-to-Vehicle), infrastructure (V2I: Vehicle-to-Infrastructure), or an external server (e.g., a cloud server, a roadside unit, or a fleet management platform, etc.).

The communication unit 110 may perform short-range communication, Vehicle-to-Everything (V2X) communication, optical communication, broadcast transmission and reception, and Intelligent Transport Systems (ITS) communication functions, and may include a Global Navigation Satellite System (GNSS) module (e.g., a GPS module). For example, the communication unit 110 may support stable data transmission at a short range using various wireless communication technologies such as Bluetooth®, Radio Frequency Identification (RFID), Infrared Data Association (IrDA), Ultra Wideband (UWB), ZigBee, Near Field Communication (NFC), Wi-Fi, Wi-Fi Direct, and Wireless USB. Furthermore, the communication unit 110 may perform long-range communication via a mobile communication module (e.g., based on Long-Term Evolution (LTE), 5G networks, or 6G networks, etc.) and a wireless Internet module, and may improve the performance of the autonomous driving system by receiving real-time data or interworking with a cloud (e.g., for high-definition map updates, over-the-air software upgrades, or real-time traffic analysis, etc.).

According to an example of the present disclosure, the communication unit 110 may receive navigation data (e.g., road event information) for an NSCC system. For example, the communication unit 110 may receive information such as a curvature of a road, speed limit information, and traffic signal information from an external server and transmit the information to the control device 100.

The storage unit 120 may include various types of memory capable of storing data, and may be integrated into the control device 100 or the processor 130, or may be configured in the form of a separate module. The storage unit 120 may include non-volatile memory (e.g., a hard disk drive, flash memory, EEPROM, SRAM, FRAM, PRAM, MRAM, , or optical storage, etc.) and volatile memory (e.g., DRAM, SDRAM, DDR-SDRAM, etc.), and may implement a memory system of various capacities and performances by combining them.

According to an example, the storage unit 120 may include a memory capable of storing and managing various data related to the autonomous driving system.

According to an example of the present disclosure, the storage unit 120 may store data received from the sensor unit 150 and a navigation server (e.g., real-time traffic updates, weather information, or map data). The storage unit 120 may provide data required by the processor 130 when determining the target speed.

According to an example of the present disclosure, the storage unit 120 may store data collected from the SCC and NSCC systems and state information of its own vehicle (e.g., third data such as vehicle speed, engine temperature, or battery charge state). In addition, the storage unit 120 may include algorithms and models necessary for determining the target speed (e.g., machine-learning prediction models, rule-based decision tables, or adaptive cruise control algorithms) based thereon.

The processor 130 communicates with various internal components of the autonomous vehicle 10, such as the communication unit 110, the storage unit 120, the input/output interface 140, the sensor unit 150, and the driving unit 160, through an electrical or operative connection, and may control the operation of each component and perform data processing. The processor 130, as a central processing unit for executing instructions and calculating data, may perform vehicle control by collecting, processing, and analyzing data in real time according to the driving environment of the vehicle (e.g., highway driving, urban stop-and-go traffic, or mountain roads).

The processor 130 may be implemented in the form of hardware, software, or a combination thereof, and may, for example, perform vehicle control logic in the form of a microcontroller, an FPGA, or an ASIC. In addition, it may also include a multi-processor configuration for controlling complex autonomous driving and driver assistance systems (e.g., lane-keeping assistance, adaptive cruise control, or collision avoidance). Such a processor configuration may support comprehensive control and stable performance of the vehicle through functions such as execution of autonomous driving and assistance systems, sensor data processing, communication data management, and driving-related determination functions.

According to an example of the present disclosure, the processor 130 may determine the target speed by comprehensively considering sensor information (the first data), navigation information (the second data), and vehicle state information (the third data). The processor 130 may set a target speed determination method differently according to a distance condition to a road event (e.g., a speed bump, a sharp curve, or a traffic congestion section).

The input/output interface 140 serves to receive an input related to vehicle control from a user and transmit vehicle control status and system operation information to the user.

The input/output interface 140 may perform a function of receiving various inputs from a user and transmitting a vehicle control status to the user. For example, the input/output interface 140 may include at least one of: an input through a physical button provided inside the autonomous vehicle 10, an input through a soft button displayed on a display of the autonomous vehicle 10, a user's voice input, and a user's gesture input (e.g., hand swipe, finger tap, or pinch zoom).

The input module may include a physical button, a soft key on a touch display, a voice recognition function, a gesture recognition function, and the like, through which a user may input commands such as an autonomous driving system activation request, a function switch, or a driving assistance setting (e.g., adjusting a following distance, enabling lane change assist, or setting maximum speed).

In addition, the input module may receive a user input through an input device provided on a steering wheel of the autonomous vehicle 10. For example, through a button mounted on the steering wheel, a driver may input a command to activate or deactivate the autonomous driving system even during driving. Such a steering wheel-based input may support a user to promptly control the autonomous driving function by providing an intuitive interface (e.g., a single-press button for lane-centering or a toggle switch for cruise control).

The output module includes a display, an audio module (e.g., a speaker), a haptic module, and the like, and may provide, to a user, a status of the autonomous driving system, a control switch request notification, and information on whether a function is activated, in visual, auditory, and tactile forms e.g., warning chimes, vibration feedback, or on-screen icons).

In addition, a user may intuitively check the status of the autonomous driving system through a head-up display (HUD), a cluster, an Audio Video Navigation (AVN) system, and a display embedded in a rear-view mirror or a side mirror. Besides, the status of the autonomous driving system may be checked through a display of a console installed in each row of the autonomous vehicle 10, an application of a user terminal, and the like (e.g., smartphone app notifications or tablet-based rear-seat displays).

According to an example of the present disclosure, the input/output interface 140 may support a user to adjust settings of the SCC and NSCC systems or check information related to target speed control. For example, a user may set a following distance of the SCC or a road event detection range of the NSCC through a user interface provided by the input/output interface 140 (e.g., slider controls, preset modes, or voice commands).

The sensor unit 150 may include a plurality of sensors that detect various driving and environmental information in real time to support stable operation of the autonomous driving system. The sensor unit 150 may measure a distance to and a speed of a surrounding object through long-range detection sensors such as a Radio Detection and Ranging (RADAR) sensor and a Light Detection and Ranging (LIDAR) sensor, and may include an ultrasonic sensor to detect an object near the autonomous vehicle 10 (e.g., a curb, a parked car, or a pedestrian).

In addition, the sensor unit 150 may include a position sensor, such as a GPS, to collect position information of the autonomous vehicle 10, and an optical sensor to provide surrounding illumination information, thereby allowing the system to respond to changes in light (e.g., day/night transitions or tunnel entry). Furthermore, the sensor unit 150 may monitor a driving control state and a user's action of the autonomous vehicle 10 by including sensors such as an acceleration pedal and deceleration pedal sensor, a steering wheel detection sensor, and a seating sensor (e.g., seatbelt buckle sensor or occupancy detection sensor).

The sensor unit 150 may include a camera. The camera may be classified into an external camera and an internal camera. The external camera recognizes the road and the surrounding environment, and the internal camera may comprehensively grasp the situation inside and outside the vehicle by detecting a driver's state (e.g., eye tracking, drowsiness detection, or distraction monitoring) or an indoor situation (e.g., passenger gestures or object placement).

The sensor unit 150 may collect a driver's biometric information or various environmental data by including a heart rate sensor, a pressure sensor, an infrared sensor, and the like (e.g., temperature sensor, CO₂ sensor, or air-quality sensor).

According to an example of the present disclosure, the sensor unit 150 may detect distance and speed information of an object in front of or behind the autonomous vehicle 10 and transmit the information to the processor 130.

According to an example of the present disclosure, the sensor unit 150 may utilize a radar and a camera to collect forward vehicle detection data for the SCC system. In addition, the sensor unit 150 may collect position information linked with a GPS for road situation recognition for the NSCC system (e.g., mapping curves, slopes, or congestion zones).

The driving unit 160 may include various components that provide a driving force necessary for driving of the autonomous vehicle 10 and control an operation of the vehicle according to a command output from the control device 100. The driving unit 160 may be composed of devices that generate and transmit power of the vehicle, such as an engine, a motor, a transmission, and a wheel drive system, and a controller that controls them, and through these components, acceleration, deceleration, and a direction change of the autonomous vehicle 10 may be performed (e.g., lane changes, merges, or emergency stops).

The driving unit 160 may be controlled to perform longitudinal control (acceleration and deceleration) and lateral control (lane keeping and changing) to maintain driving stability. For example, upon receiving a command from the control device 100, the driving unit 160 allows the vehicle to follow a driving path by adjusting an output of a motor or a rotation speed and direction of wheels (e.g., torque vectoring, regenerative braking, or wheel-specific speed control).

In addition, the driving unit 160 may include a brake system to reduce the vehicle speed or stop the vehicle during driving (e.g., automatic emergency braking or hill-hold braking). The driving unit 160 may control the autonomous vehicle 10 through an electric motor in the case of an electric vehicle, and based on engine output in the case of an internal combustion engine vehicle.

According to an example of the present disclosure, the driving unit 160 may perform fuel-efficient vehicle control by accelerating or decelerating the speed of the vehicle in accordance with the target speed determined by the processor 130 (e.g., smoothing acceleration/deceleration to reduce fuel or battery consumption).

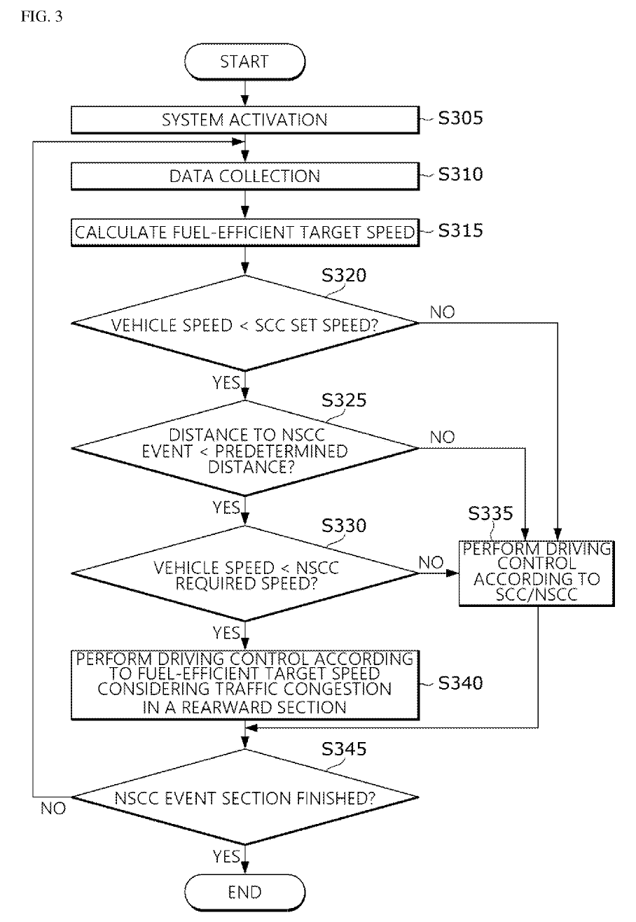

FIG. 2 shows an example of a speed control operation of an autonomous vehicle according to an example of the present disclosure.

The processor 130 may collect, via the sensor unit 150, data of a sensor-based Smart Cruise Control (SCC) system related to surrounding objects of the autonomous vehicle 10 (S210) (e.g., forward vehicles, rear vehicles, roadside structures, or pedestrians, etc.).

Specifically, the sensor unit 150 may generate the first data by detecting a position, a distance, a relative speed, and a relative acceleration of a surrounding object, and the like, using various sensors such as a RADAR, a LIDAR, an ultrasonic sensor, or a camera disposed in front of or behind the vehicle (e.g., front bumper-mounted radar, rear parking ultrasonic sensors, or 360-degree surround cameras, etc.). The processor 130 may identify, in real time, a current distance between a surrounding object and the autonomous vehicle 10 and a change in a relative speed and acceleration through the first data received from the sensor unit 150 (e.g., detecting a forward car braking, a bicycle overtaking, or a stationary obstacle appearing, etc.).

For example, if a relative speed with respect to a forward vehicle decreases to be equal to or less than a certain threshold, or if a distance between the two vehicles is less than a preset safety distance (e.g., 30 m, 20 m, or 10 m, etc.), the sensor unit 150 may transmit this information to the processor 130. The processor 130 may, based on the first data, prepare information for determining a risk of collision with a surrounding vehicle or object or for determining a required speed for deceleration control (e.g., gentle braking, emergency braking, or lane change preparation, etc.). In addition, a situation in which a rear vehicle is rapidly approaching or is stationary may also be included in the first data and may be utilized for control that considers rear safety of the vehicle (e.g., avoiding being rear-ended in stop-and-go traffic or when merging, etc.).

Next, the processor 130 may collect, via the communication unit 110, the second data associated with road events from a Navigation-based Smart Cruise Control (NSCC) system (S220).

Specifically, the communication unit 110 may transmit navigation information received from an external server or infrastructure to the processor 130. The navigation information may, based on map data, include information such as a position and a shape of various events existing on a road (e.g., a speed limit section, a speed bump, a traffic congestion section, a road construction section, a curved section, , a toll gate, or a school zone, etc.), a speed limit, and a driving condition (e.g., slippery road surface, fog area, or lane closure, etc.). The processor 130 may identify in advance information related to a road environment existing in front of the vehicle using such second data.

For example, the NSCC system may provide a position of a speed bump existing on a road in front of the vehicle and information on a required speed for passing the corresponding speed bump (e.g., 20 km/h, 15 km/h, or 10 km/h, etc.). In addition, when a traffic congestion section exists ahead, the NSCC system may transmit detailed information such as a position of the corresponding section, a severity of the congestion, and an expected passing speed to the processor 130 (e.g., “congestion begins in 400 m, average speed 15 km/h, ends in 2 km,” etc.). The processor 130 may use this information to determine in advance a target speed (e.g., a required speed) for the autonomous vehicle 10 to appropriately respond to the corresponding road event.

The processor 130 may determine the target speed of the autonomous vehicle 10 based on the first data obtained from the SCC system based on sensor information and the second data obtained from the NSCC system based on navigation information (S230).

Herein, "target speed" may be interpreted to mean a goal speed that the autonomous vehicle is intended to reach, determined by maintaining a safe distance with a forward vehicle and considering road events such as a curvature of a road, a speed limit, a traffic signal, and the like (e.g., pedestrian crossings, steep gradients, or sharp turns, etc.).

First, the processor 130 may determine a target driving speed of the vehicle (hereinafter referred to as a 'set speed') by considering a relative distance and speed with respect to a surrounding object (e.g., a forward or rear vehicle, a motorcycle, or a large truck, etc.) based on the first data (sensor information). In addition, the processor 130 may determine another target driving speed (e.g., a required speed) of the vehicle by considering a specific event on a road (e.g., a speed bump, a speed limit section, a traffic congestion section, , a construction zone, etc.) based on the second data collected via the NSCC system.

In this case, the processor 130 may first respectively and independently determine the SCC set speed and the NSCC required speed. Then, in consideration of a specific condition (e.g., a distance to a forward event, a current vehicle speed, , a road gradient, or a weather-affected section, etc.), the processor 130 may determine the target speed of the autonomous vehicle 10 by either selecting a lower of the two speeds or calculating a separate optimized speed that is equal to or less than the two speeds.

According to an example of the present disclosure, in the process of determining the target speed, the processor 130 may determine the target speed not by simply comparing the two speeds, but by comprehensively judging the current vehicle state and road situation so that acceleration and deceleration may be minimized or reduced within a fuel-efficient range (e.g., avoiding brake-gas-brake cycles, reducing battery drain, or maintaining optimal RPM, etc.).

For example, the processor 130 may lower the SCC set speed when a distance to a forward vehicle is decreasing. When an NSCC event such as a forward speed bump is imminent, the processor 130 may also consider the NSCC required speed and may determine the target speed to be equal to or less than a lower of the SCC set speed and the NSCC required speed (e.g., lowering from 60 km/h to 30 km/h before reaching the bump, etc.).

The processor 130 may control driving of the autonomous vehicle 10 in accordance with the determined target speed (S240).

Specifically, the processor 130 may control the driving unit 160 so that the vehicle reaches the target speed by comparing a current speed of the autonomous vehicle 10 with the determined target speed. The processor 130 may adjust the longitudinal speed of the vehicle by transmitting a signal to the driving unit 160 to accelerate the vehicle if the current speed is lower than the target speed, and transmitting a signal to the driving unit 160 to decelerate the vehicle if the current speed is higher than the target speed (e.g., applying throttle increase, regenerative braking, or friction braking, etc.).

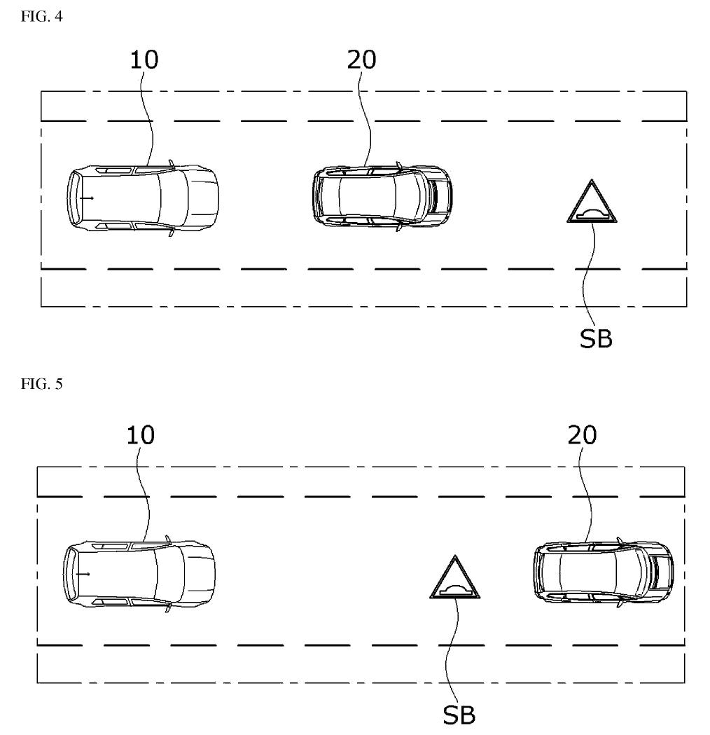

FIG. 3 shows an example of a speed control operation of an autonomous vehicle according to an example of the present disclosure.

The processor 130 may activate a speed control system of the autonomous vehicle 10 (S305).

The processor 130 may initiate a speed control strategy that integrates Smart Cruise Control (SCC) and Navigation-based Smart Cruise Control (NSCC).

Specifically, the processor 130 may receive, via the input/output interface 140, an input from a user requesting activation of the autonomous driving system (e.g., pressing a steering wheel button, touching a display icon, or giving a voice command, etc.). In addition, the processor 130 may also automatically initialize and activate the autonomous driving system when the vehicle is started. When the system is activated, the processor 130 may check whether each component of the control device 100, including the sensor unit 150, the communication unit 110, and the storage unit 120, is operating normally (e.g., performing self-diagnostics or displaying system-ready indicators, etc.).

For example, the processor 130 may check whether each sensor of the sensor unit 150 is operating normally during the activation process. The processor 130 may also check whether navigation data (NSCC data) can be received via the communication unit 110. In addition, the processor 130 may complete the system activation by loading previous driving data or initially set data stored in the storage unit 120 (e.g., user-preferred following distance, default maximum speed, or last known target speed, etc.).

The processor 130 may respectively collect data of the sensor-based SCC system and the navigation-based NSCC system via the sensor unit 150 and the communication unit 110 of the autonomous vehicle 10 (S310).

Specifically, the processor 130 may collect, from the sensor unit 150, the first data including information about a forward and rear object of the autonomous vehicle 10 (e.g., another vehicle, a cyclist, a structure, or a pedestrian, etc.). The sensor unit 150 may provide information such as a relative distance, a relative speed, and a relative acceleration with respect to an object around the vehicle to the processor 130. In addition, the processor 130 may receive, via the communication unit 110, the second data including information on various events on a road (e.g., a speed limit section, a speed bump, a traffic congestion section, a curvature, , a school zone, or a toll booth, etc.) from an external navigation system.

For example, the radar and the camera of the sensor unit 150 may collect a current distance to a forward vehicle as 30 meters and a relative speed as 10 km/h, and transmit this to the processor 130. In addition, the communication unit 110 may receive information from the navigation system that a speed bump exists at a point 400 meters ahead and that a required speed for passing the corresponding speed bump is 20 km/h and transmit the information to the processor 130 (e.g., along with gradient data, curvature info, or lane-closure alerts, etc.).

Furthermore, the processor 130 may receive state information(e.g., a current speed, RPM, a gear position, a battery charge level, or an engine temperature, etc.) of autonomous vehicle 10 from the sensor unit 150 or the driving unit 160.

The processor 130 may prepare the data thus collected by storing it in the storage unit 120 so that the data can be utilized when determining the target speed later.

The processor 130 may determine a fuel-efficient target speed by comprehensively considering a set speed according to the first data collected from the sensor information-based SCC system and a required speed according to the second data collected from the navigation information-based NSCC system (S315) (e.g., 50 km/h from SCC vs. 30 km/h from NSCC, selecting 30 km/h as the target, etc.).

The processor 130 may determine and set a basic target speed in advance through this step. When determining the basic target speed, the processor 130 may determine whether deceleration requests according to the SCC and the NSCC have occurred continuously (e.g., sequentially or back-to-back, etc.) within a predetermined section or a predetermined time, and when they have occurred continuously, may determine that a condition for applying the fuel-efficient control strategy proposed in the present disclosure has been satisfied.

Specifically, if a deceleration section caused by the SCC system and a deceleration event according to the NSCC system (e.g., a speed limit section, a speed bump, or a congestion zone, etc.) are respectively independent but exist continuously and adjacent to each other, the processor 130 may determine the decelerations caused by the SCC and the NSCC as a continuous event instead of processing them independently. Through this determination of a continuous event occurrence, the processor 130 may set the basic target speed to maintain the current decelerated state without additional acceleration within a specific predetermined distance (e.g., 500 m, 800 m, or 1 km, etc.) or a specific time (e.g., 5 s, 10 s, or 15 s, etc.).

For example, when the autonomous vehicle 10 is already decelerating due to a forward vehicle, and deceleration is expected again because an NSCC event such as a speed bump exists at a close distance (e.g., less than 500 m, 400 m, or 300 m, etc.), the processor 130 may recognize this as 'a continuous deceleration event'. At this time, to minimize repeated acceleration and deceleration, the processor 130 may preset a fuel-efficient target speed that considers the required speeds of the two events and store it in advance in the storage unit 120 (e.g., caching the value with a time stamp or distance tag, etc.).

In addition, the processor 130 may determine the set speed of the SCC system and the required speed of the NSCC system respectively, and then may determine the basic target speed as a lower of the two speeds. The basic target speed thus set may become a reference for determining whether to reflect it in the actual driving control by considering the vehicle speed and the distance condition to the road event in a subsequent step (e.g., apply when within a first threshold, defer when beyond a second threshold, etc.).

Specifically, the processor 130 may determine the set speed of the SCC system according to the distance to and speed of a forward or rear object (e.g., a forward vehicle, a truck ahead, a motorcycle behind, or a merging vehicle, etc.). In addition, the processor 130 may determine the required speed of the NSCC system as a limited speed for passing a specific event on the road (e.g., a speed bump, a speed limit section, a traffic congestion section, etc.). The processor 130 may determine the fuel-efficient target speed based on a lower of the two speeds by comparing the set speed and the required speed (e.g., 45 km/h vs. 30 km/h ⇒ 30 km/h, etc.).

For example, when the set speed determined by the SCC system is 50 km/h because the distance to a forward vehicle is short, and the required speed determined by the NSCC system by considering a road event (e.g., a speed bump or a speed limit section, etc.) is 30 km/h, the processor 130 may compare the two speeds and determine the target speed based on the lower speed of 30 km/h. The processor 130 may additionally perform fine adjustment to a speed optimized for fuel efficiency by considering the current state of the autonomous vehicle 10 (e.g., RPM, gear state, , battery state-of-charge, or drivetrain temperature, etc.).

For example, the processor 130 may determine the target speed within a range of 30 km/h or less by additionally reflecting a condition of maintaining the current RPM of the autonomous vehicle 10 to be within an optimal fuel efficiency range (e.g., 1,500–2,000 RPM, etc.). The operation of determining the target speed by additionally considering the current state of the autonomous vehicle 10 may be performed in step S315, but alternatively, it may not be performed in step S315 and may instead be performed in step S340 to be described later. In addition, it is also possible for the operation to be performed in both step S315 and step S340 (e.g., preliminary setting at S315 and refinement at S340, etc.).

The processor 130 may check the set speed preset by a user in the sensor information-based SCC system, and determine whether the current speed of the autonomous vehicle 10 is lower than the set speed (S320) (e.g., compare current speed vs. stored setpoint at 10 Hz, etc.).

Specifically, the SCC system may store a speed value directly input by a driver via the input/output interface 140 as the set speed (e.g., via a steering-wheel button, a touchscreen soft key, or a voice command, etc.). The processor 130 may load the set speed value stored in the storage unit 120 and compare it in real time with the current speed of the autonomous vehicle 10 (e.g., using sensor fusion from wheel speed, GPS, or vision odometry, etc.).

If the current speed of the autonomous vehicle 10 is lower than the set speed (S320: YES), the processor 130 may determine whether a remaining distance to a road event collected from the navigation information-based NSCC system is less than a predetermined distance (S325) (e.g., 500 m threshold, etc.).

Specifically, the processor 130 may calculate or check, in real time, the remaining distance to a road event (e.g., a speed bump, a traffic congestion section, a speed limit section, or a toll gate, etc.) located in front of the autonomous vehicle 10 by referring to the navigation information (NSCC data) received via the communication unit 110.

The processor 130 may determine whether the calculated remaining distance is less than the predetermined distance. For example, the predetermined distance may mean a reference distance at which it is determined to be advantageous for the autonomous vehicle 10 to drive in the current state without sudden acceleration or deceleration (e.g., avoid short burst acceleration, reduce brake wear, or save energy, etc.). If the distance to the NSCC event is shorter than the predetermined distance, the processor 130 may determine that there is a need to utilize the fuel-efficient target speed by suppressing sudden acceleration of the vehicle or applying a deceleration state maintenance strategy (e.g., hold current reduced speed, extend coasting, or apply gentle braking, etc.).

For example, the processor 130 may determine that the distance to a speed bump located ahead (e.g., with a speed limit of 20 km/h) is 300 m. If the predetermined distance is 500 m, the processor 130 may determine that the condition that the distance to the NSCC event (the speed bump) is less than the predetermined distance (500 m) is satisfied. Therefore, the processor 130 may, in a subsequent step (S330), finally determine whether to apply the fuel-efficient target speed by additionally comparing the required speed of the NSCC with the current vehicle speed (e.g., current 25 km/h vs. required 20 km/h, etc.).

On the other hand, if the distance to the NSCC event is equal to or greater than the predetermined distance (e.g., 500 m, 1,000 m, or 1,500 m, etc.), the processor 130 may determine that the necessity for the vehicle to immediately apply the fuel-efficient target speed is low, and may perform general driving control according to the SCC set speed or the NSCC required speed.

The processor 130 may determine whether the current speed of the autonomous vehicle 10 is lower than the required speed determined from the navigation information-based NSCC system (S330) (e.g., compare current speed vs. event-specific limit, etc.).

Specifically, the processor 130 may check the limited speed for passing a specific event on a road (e.g., a speed bump, a speed limit section, , or a school zone, etc.) provided by the NSCC system, that is, the required speed. After measuring or checking the current speed of the autonomous vehicle 10 in real time via the sensor unit 150, the processor 130 may determine whether the current speed is lower by comparing it with the required speed of the NSCC system (e.g., current 25 km/h vs. required 30 km/h ⇒ below, etc.).

For example, the processor 130 may assume that the required speed for passing a speed bump on a road ahead is set to 30 km/h. The processor 130 may determine that the current speed of the autonomous vehicle 10 is 25 km/h, which is lower than the NSCC required speed. In such a case, the processor 130 may determine that it is desirable to maintain the current decelerated state without unnecessary additional acceleration, in combination with the state in which the remaining distance to the NSCC event is less than the predetermined distance (e.g., < 500 m, etc.).

Alternatively, if the current vehicle speed is higher than the NSCC required speed (30 km/h), the processor 130 may control driving of the autonomous vehicle 10 by considering the distance to the NSCC event and the current speed (e.g., apply gentle braking now vs. delayed braking closer to the event, etc.).

According to a determination result of the preceding steps (S320, S325, and S330), if it is determined that it is not necessary to immediately apply the fuel-efficient target speed, the processor 130 may control driving of the autonomous vehicle 10 according to the set speed of the sensor information-based SCC system or the required speed of the navigation information-based NSCC system (S335).

Specifically, if the current speed of the autonomous vehicle 10 is not less than the SCC set speed or the NSCC required speed, that is, if it is determined that a separate deceleration state maintenance strategy is unnecessary because the current speed is already sufficient or high, the processor 130 may perform general vehicle control according to the set speed of the existing SCC system or the required speed of the NSCC system. The processor 130 may perform acceleration, deceleration, or speed maintenance control of the vehicle via the driving unit 160 based on the speed presented by the SCC or NSCC system (e.g., throttle modulation, regenerative braking, or cruise hold, etc.).

For example, if the speed of the autonomous vehicle 10 is lower than the SCC set speed and the distance to the NSCC event is sufficiently far (e.g., 500 m or more, 1 km or more, etc.), the processor 130 may gradually accelerate the speed of the autonomous vehicle 10 to the SCC set speed. In this case, based on a relationship between the remaining distance to the NSCC event and a first distance (e.g., 500 m) and a second distance (e.g., 1500 m) serving as comparison criteria, the processor 130 may select at least one of slow acceleration or a required acceleration as an acceleration method for the autonomous vehicle 10 (e.g., choose gentle ramp vs. faster ramp, etc.).

Specifically, if the distance to the NSCC event is equal to or greater than the second distance (e.g., 1500 m), the processor 130 may perform acceleration control by applying a predetermined required acceleration so that the autonomous vehicle 10 may reach the set speed more quickly (e.g., meet a merging window or clear rear pressure, etc.).

On the other hand, if the distance to the NSCC event is equal to or greater than the first distance (e.g., 500 m) and less than the second distance (e.g., 1500 m), the processor 130 may apply a slow acceleration strategy to reach the set speed more slowly, considering that a situation may arise in which deceleration control must be performed again soon (e.g., upcoming bump, curve, or congestion, etc.).

At this time, the processor 130 may control the driving unit 160 by instructing acceleration so that the autonomous vehicle 10 may smoothly reach the set speed (e.g., torque limit, gear selection, or motor current ramp, etc.).

In addition, if the vehicle is driving at a speed exceeding the required speed of an NSCC event located ahead (e.g., a speed limit section, or school zone, etc.), the processor 130 may control the driving unit 160 to decelerate the autonomous vehicle 10 to the NSCC required speed. The processor 130 may lower the vehicle speed to the NSCC required speed by transmitting a deceleration signal, including a decrease in engine output or brake operation, to the driving unit 160 (e.g., engine braking, regenerative braking, or hydraulic braking, etc.).

According to a determination result of the preceding steps (S320, S325, and S330), if a condition that the current speed of the vehicle is less than the SCC set speed and the NSCC required speed, and that the distance to the NSCC event is less than the predetermined distance (e.g., 500 m) is satisfied, the processor 130 may control driving of the autonomous vehicle 10 by applying the fuel-efficient target speed (S340).

Specifically, the processor 130 may determine a target speed that can optimize fuel efficiency based on a lower of the SCC set speed and the NSCC required speed, and by considering the current state of the autonomous vehicle 10 (e.g., RPM and gear state, battery temperature, or payload, etc.).

For example, the processor 130 may assume a situation in which the vehicle is already driving in a decelerated state (e.g., at 50 km/h) due to a forward vehicle, and an NSCC event is imminent at less than a predetermined distance (e.g., 500 m) because there is a speed bump immediately ahead. If the SCC set speed is 70 km/h and the speed required by the NSCC system for the speed bump is 30 km/h, the processor 130 may determine the fuel-efficient target speed to be at a level equal to or lower than 30 km/h, which is the lower of the two speeds, without separate additional acceleration (e.g., hold 30 km/h or smoothly reduce to 25 km/h, etc.).

Specifically, the processor 130 may determine a separate speed so that the RPM and gear state of the autonomous vehicle 10 are maintained in the most fuel-efficient range. For example, it may be assumed that the vehicle is currently driving in third gear at 2,000 RPM, and that fuel efficiency is optimized in the RPM range of 1,500 to 2,000. Considering this state, the processor 130 may set the target speed to maintain a speed equal to or lower than 30 km/h (e.g., 28 km/h to keep RPM near 1,800, etc.).

Meanwhile, in step S340, the processor 130 may determine whether to control the autonomous vehicle 10 with the fuel-efficient target speed by additionally considering whether a rear section is congested (e.g., dense traffic directly behind, frequent stops, or tailgating, etc.).

Specifically, in a state where the conditions of steps S320, S325, and S330 are all satisfied, if it is determined that the rear section of the autonomous vehicle 10 is not congested, the processor 130 may recognize the situation as one where a continuous deceleration event exists, and may control driving of the autonomous vehicle 10 in accordance with the fuel-efficient target speed (e.g., continue gentle coasting, etc.).

Alternatively, if it is determined that congestion has occurred in the rear section of the autonomous vehicle 10, the processor 130 may control the autonomous vehicle 10 to reach the set speed by considering relative distance information between the autonomous vehicle 10 and a congested rear vehicle, without selecting the fuel-efficient target speed. In this case, the processor 130 may control the autonomous vehicle 10 to reach the set speed in a manner of increasing its speed using slow acceleration or an SCC required acceleration according to the situation (e.g., choose a faster ramp if a tailgater is too close, etc.).

For example, if the distance between the autonomous vehicle 10 and the congested rear vehicle is equal to or greater than a predetermined reference distance, the processor 130 may determine that driving pressure from the rear vehicle is low, and may control the autonomous vehicle 10 to reach the set speed using a slow acceleration method that relatively gently increases the speed (e.g., low jerk profile, etc.).

On the other hand, if the distance between the autonomous vehicle 10 and the congested rear vehicle is less than a predetermined reference distance, the processor 130 may determine that the rear vehicle is approaching in a congested state in close proximity to the autonomous vehicle 10, and may control the autonomous vehicle 10 to quickly reach the set speed by applying a predetermined SCC required acceleration (e.g., higher torque request up to a comfort limit, etc.).

Whether the rear section is congested may be determined, for example, based on object information detected via a radar, a LIDAR, or a rear camera included in the sensor unit 150 (e.g., object count, inferred queue length, or low relative speeds, etc.). The processor 130 may determine that the rear section is congested if an object located behind the autonomous vehicle 10 is stopped at a fixed position for a certain period of time or more, or if a plurality of objects driving at a low speed in close proximity to the autonomous vehicle 10 are detected (e.g., three or more vehicles within 20 m at < 10 km/h, etc.).

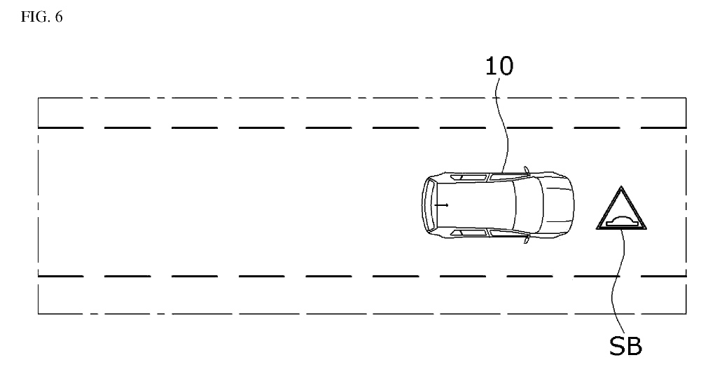

This condition may be satisfied if a relative speed with an object located behind the vehicle is maintained below a predetermined threshold, and a rate of change in distance between objects is small or a congestion pattern continues for a certain period of time or more (e.g., < 2 km/h relative speed and < 1 m/s distance change for ≥ 10 s, etc.). Considering this rear congestion state, the processor 130 may select an acceleration strategy to the set speed so that the autonomous vehicle 10 is not maintained in an unnecessarily decelerated state (e.g., avoid lingering at 20–25 km/h when 30 km/h set speed is safe, etc.). Specific driving situations according to examples of the present disclosure will be described with reference to FIGS. 4, 5 and 6.

In FIG. 4, the autonomous vehicle 10 may, based on the sensor information-based SCC system, drive in a state of having been decelerated to a speed lower than the set speed due to a forward vehicle 20. The forward vehicle 20 may drive at a low speed (e.g., 30 km/h, 25 km/h, or 20 km/h, etc.) due to a specific event such as a speed bump (SB), and accordingly, the autonomous vehicle 10 may drive at a significantly lower speed than the set speed (e.g., 80 km/h).

In FIG. 5, when the forward vehicle 20 accelerates and the distance increases, the autonomous vehicle 10 may rapidly accelerate again to reach the existing SCC set speed (e.g., 80 km/h). However, since it has to decelerate again later in the speed bump (SB) event section provided by the NSCC system, an inefficient situation of performing sudden acceleration and then sudden deceleration in a short time may occur (deceleration, acceleration, and repetition of deceleration) (e.g., acceleration–brake–acceleration cycles, increased fuel or battery use, or passenger discomfort, etc.).

To solve this problem, in FIG. 6, if the distance between continuously occurring events via the sensor information-based SCC system and the navigation information-based NSCC system is within a predetermined distance (e.g., 500 m, 400 m, or 300 m, etc.), the processor 130 may determine the target speed in a manner that maintains the current decelerated state without unnecessary intermediate acceleration (e.g., coast or gently hold speed, etc.).

That is, if the vehicle is already in a decelerated state due to the forward vehicle 20 and an NSCC event such as a speed bump is scheduled immediately after, the processor 130 may determine the fuel-efficient target speed by considering in advance the required speed of the NSCC system in the speed bump section, without immediately accelerating even after the forward vehicle 20 disappears. The processor 130 may reduce unnecessary acceleration and re-deceleration (e.g., repeated acceleration–deceleration cycles) by controlling the driving unit 160 to maintain this determined fuel-efficient target speed (e.g., hold ≤ required speed, avoid short bursts, etc.).

The processor 130 may control the driving unit 160 to maintain the corresponding speed or to smoothly decelerate when necessary, by transmitting the fuel-efficient target speed thus determined to the driving unit 160 (e.g., apply regenerative braking, light hydraulic braking, or throttle lift, etc.).

The processor 130 may determine whether the autonomous vehicle 10 has completely passed through a road event section provided from the navigation information-based NSCC system, and thus whether the corresponding event has ended (S345).

Specifically, the processor 130 may check the position and range of a road event (e.g., a speed bump, a speed limit section, a traffic congestion section, etc.) using the NSCC data received from the communication unit 110. The processor 130 may continuously measure the current position of the autonomous vehicle 10 via a GPS sensor or other position detection device of the sensor unit 150, and may determine whether the vehicle has completely exited the corresponding event section by comparing this with the section in which the NSCC event is set (e.g., event start/end markers in map data, etc.).

For example, it may be assumed that a speed bump section provided via the NSCC system is at a specific position on a road (e.g., from a 700 m point to an 800 m point, etc.). The processor 130 may determine, via the GPS information of the sensor unit 150, that the corresponding event section has ended because the current position of the vehicle has exceeded the 800 m point. When the event has ended, the processor 130 may determine that it is no longer necessary to limit the driving speed of the vehicle by considering the corresponding NSCC event, and may return to speed maintenance control of a general SCC system or gradually increase the speed based on the SCC set speed set by the user (e.g., smooth ramp-up to set speed, etc.).

On the other hand, if the processor 130 determines that the current position of the vehicle is still within the NSCC event section (e.g., within the speed bump section, a school zone, or a construction zone, etc.), it may continue to maintain the fuel-efficient target speed control (S340) or continuously perform the speed control of the SCC/NSCC (S335) until it exits the corresponding section (e.g., maintain ≤ required speed, defer acceleration, etc.).

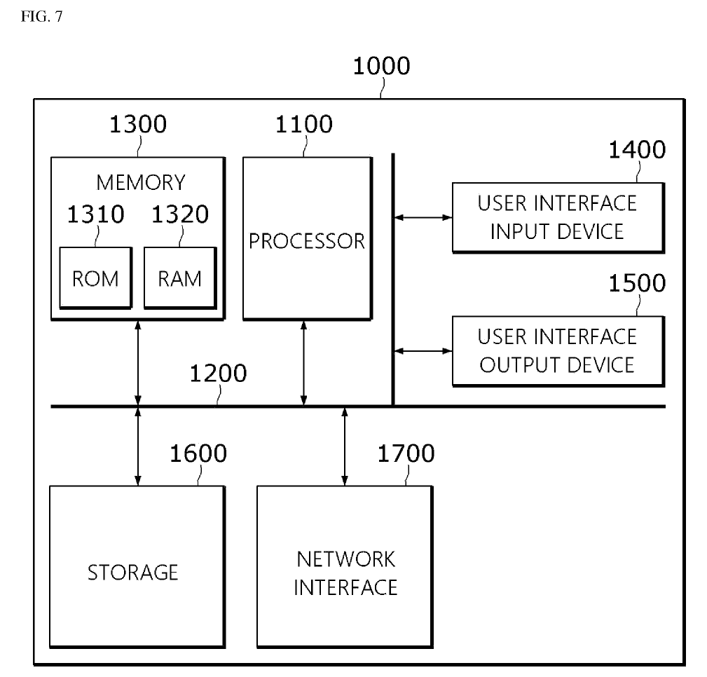

FIG. 7 shows an example computing system (e.g., a computing device of a vehicle or any other apparatus). One or more controllers, processors, etc. described herein, such as one or more components of the vehicle 10 and any other components and devices disclosed herein, may be implemented by or in the computing system as shown in FIG. 7.

A computing system 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random-access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example example(s) disclosed in the specification may be directly implemented with a hardware module, a software module, or a combination of the hardware module and the software module, which is executed by the processor 1100. The software module may reside on a storage medium (e.g., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

According to an example of the present disclosure, a control device for an autonomous vehicle comprises: a memory; and one or more processors coupled to the memory, wherein the one or more processors are configured to: collect first data associated with surrounding objects from a Smart Cruise Control (SCC) system based on sensor information; collect second data associated with road events from a Navigation-based Smart Cruise Control (NSCC) system based on navigation information; determine a target speed of the autonomous vehicle based on the first data and the second data; and control driving of the autonomous vehicle in accordance with the determined target speed.

In an example of the present disclosure, in the control device for an autonomous vehicle, the determination of the target speed is further based on third data associated with a state of the autonomous vehicle.

In an example of the present disclosure, in the control device for an autonomous vehicle, the third data comprises at least one of a speed, a gear state, or a revolutions per minute (RPM) of the autonomous vehicle.

In an example of the present disclosure, in the control device for an autonomous vehicle, the first data comprises at least one of a distance between the autonomous vehicle and a surrounding object, a speed of a surrounding object, or an acceleration of a surrounding object.

In an example of the present disclosure, in the control device for an autonomous vehicle, the second data comprises at least one of a curvature of a road, a speed bump, a gradient of a road, a traffic congestion section, speed limit information, or traffic signal information.

In an example of the present disclosure, in the control device for an autonomous vehicle, the surrounding objects comprise objects located in front of or behind the autonomous vehicle.

In an example of the present disclosure, in the control device for an autonomous vehicle, the one or more processors are configured to control driving of the autonomous vehicle according to the determined target speed if : a speed of the autonomous vehicle is less than a set speed based on the first data; the speed of the autonomous vehicle is less than a required speed based on the second data; and a distance from the autonomous vehicle to a road event identified via the second data is less than a predetermined distance.

In an example of the present disclosure, in the control device for an autonomous vehicle, the one or more processors are configured to determine the target speed based on a lower of the set speed and the required speed, the target speed being maintained at or below the lower speed for a section of road leading to the road event.

In an example of the present disclosure, in the control device for an autonomous vehicle, the one or more processors are further configured to determine the target speed to be at or below the lower speed further based on third data associated with a state of the autonomous vehicle.

In an example of the present disclosure, in the control device for an autonomous vehicle, the one or more processors are configured to determine the target speed differently according to a remaining distance to a road event identified through the second data.

According to an example of the present disclosure, a method for controlling an autonomous vehicle comprises: collecting first data associated with surrounding objects from a Smart Cruise Control (SCC) system based on sensor information; collecting second data associated with road events from a Navigation-based Smart Cruise Control (NSCC) system based on navigation information; determining a target speed of the autonomous vehicle based on the first data and the second data; and controlling driving of the autonomous vehicle in accordance with the determined target speed.

In some examples, in the method for controlling an autonomous vehicle, determining the target speed is further based on third data associated with a state of the autonomous vehicle.

In some examples, in the method for controlling an autonomous vehicle, the third data comprises at least one of a speed, a gear state, or a revolutions per minute (RPM) of the autonomous vehicle.

In some examples, in the method for controlling an autonomous vehicle, the first data comprises at least one of a distance between the autonomous vehicle and a surrounding object, a speed of a surrounding object, or an acceleration of a surrounding object.

In some examples, in the method for controlling an autonomous vehicle, the second data comprises at least one of a curvature of a road, a speed bump, a gradient of a road, a traffic congestion section, speed limit information, or traffic signal information.

In some examples, in the method for controlling an autonomous vehicle, the surrounding objects comprise objects located in front of or behind the autonomous vehicle.

In some examples, in the method for controlling an autonomous vehicle, controlling driving of the autonomous vehicle is performed if: a speed of the autonomous vehicle is less than a set speed based on the first data; the speed of the autonomous vehicle is less than a required speed based on the second data; and a distance from the autonomous vehicle to a road event identified via the second data is less than a predetermined distance.

In some examples, in the method for controlling an autonomous vehicle, determining the target speed comprises determining the target speed based on a lower of the set speed and the required speed, the target speed being maintained at or below the lower speed for a section of road leading to the road event.

In some examples, in the method for controlling an autonomous vehicle, determining the target speed comprises determining the target speed to be at or below the lower speed further based on third data associated with a state of the autonomous vehicle.

In some examples, in the method for controlling an autonomous vehicle, determining the target speed comprises determining the target speed differently according to a remaining distance to a road event identified through the second data.

According to an example of the present disclosure, by determining a target speed by integrally considering data from a Smart Cruise Control (SCC) system based on sensor information and a Navigation-based Smart Cruise Control (NSCC) system based on navigation information, a number of unnecessary accelerations and decelerations of an autonomous vehicle may be reduced, and driving fuel efficiency may be improved.

Although the preferable examples of the present disclosure have been described above, it will be understood by those of ordinary skill in the art that various modifications and changes may be made to the present disclosure without departing from the spirit and scope of the disclosure as defined in the following claims.

What is claimed is:

1. An apparatus of a vehicle, the apparatus comprising:
a communication interface configured to receive:
first data, from a Smart Cruise Control (SCC) system, based on sensor information and
second data, from a Navigation-based Smart Cruise Control (NSCC) system, based on navigation information;
a processor; and
a memory storing at least one instruction that, when executed by the processor, is configured to cause the apparatus to:
obtain, via the communication interface, the first data, wherein the first data is associated with at least one object in a surrounding environment of the vehicle,
obtain, via the communication interface, the second data, wherein the second data is associated with at least one event on a road on which the vehicle is traveling,
output, based on the first data and the second data, a signal indicating a target speed of the vehicle, and
control, based on the signal, autonomous driving of the vehicle.

2. The apparatus of claim 1, wherein the target speed is determined based on third data associated with a state of the vehicle and in combination with the first data obtained from the SCC system and the second data obtained from the NSCC system,
wherein the SCC system is configured to obtain at least one of a distance between the vehicle and the at least one object, a speed of the at least one object, or an acceleration of the at least one object,
wherein the NSCC system is configured to obtain at least one of a curvature of the road, a speed bump on the road, a gradient of the road, a traffic congestion section on the road, speed limit information on the road, or traffic signal information on the road, and
wherein the first data and the second date are fused by comparing a set speed of the SCC system with a required speed of the NSCC system and recognizing continuous deceleration events within a predetermined distance or time.

3. The apparatus of claim 2, wherein the third data comprises at least one of:
a speed of the vehicle,
a gear state of the vehicle, or
a revolutions per minute (RPM) of the vehicle.

4. The apparatus of claim 1, wherein the first data comprises at least one of:
a distance between the vehicle and the at least one object,
a speed of the at least one object, or
an acceleration of the at least one object.

5. The apparatus of claim 1, wherein the second data comprises at least one of:
a curvature of the road,
a speed bump on the road,
a gradient of the road,
a traffic congestion section on the road,
speed limit information on the road, or
traffic signal information on the road.

6. The apparatus of claim 1, wherein the at least one object comprises objects located in front of or behind the vehicle.

7. The apparatus of claim 1, wherein the at least one instruction, when executed by the processor, is configured to cause the apparatus to control driving of the vehicle based on:
the target speed,
a current speed of the vehicle being less than a first speed that is determined based on the first data,
the current speed of the vehicle being less than a second speed that is determined based on the second data, and
a distance from the vehicle to a location associated with the at least one event being less than a predetermined distance.

8. The apparatus of claim 7, wherein the at least one instruction, when executed by the processor, is configured to cause the apparatus to determine the target speed based on a lower speed of the first speed and the second speed, wherein the target speed is at or below the lower speed for a section of the road leading to the at least one event.

9. The apparatus of claim 8, wherein the at least one instruction, when executed by the processor, is configured to cause the apparatus to determine the target speed to be at or below the lower speed based on third data associated with a state of the vehicle.

10. The apparatus of claim 1, wherein the at least one instruction, when executed by the processor, is configured to cause the apparatus to determine the target speed differently based on a remaining distance to a location associated with the at least one event.

11. A method performed by an apparatus of a vehicle, the method comprising:
obtaining, via a communication interface of the apparatus, first data associated with at least one object in a surrounding environment of the vehicle, from a Smart Cruise Control (SCC) system, based on sensor information;
obtaining, via the communication interface, second data associated with at least one event on a road on which the vehicle is traveling, from a Navigation-based Smart Cruise Control (NSCC) system, based on navigation information;
outputting, based on the first data and the second data, a signal indicating a target speed of the vehicle; and
controlling, based on the signal, autonomous driving of the vehicle.

12. The method of claim 11, further comprising determining the target speed based on the first data, the second data, and third data, wherein the third data is associated with a state of the vehicle.

13. The method of claim 12, wherein the third data comprises at least one of:
a speed of the vehicle,
a gear state of the vehicle, or
a revolutions per minute (RPM) of the vehicle.

14. The method of claim 11, wherein the first data comprises at least one of:
a distance between the vehicle and the at least one object,
a speed of the at least one object, or
an acceleration of the at least one object.

15. The method of claim 11, wherein the second data comprises at least one of:
a curvature of the road,
a speed bump on the road,
a gradient of the road,
a traffic congestion section on the road,
speed limit information on the road, or
traffic signal information on the road.

16. The method of claim 11, wherein the at least one object comprise objects located in front of or behind the vehicle.

17. A vehicle comprising:
a sensor configured to obtain first data associated with at least one object in a surrounding environment of the vehicle, wherein the first data comprises at least one of a distance from the vehicle to the at least one object, a speed of the at least one object, or an acceleration of the at least one object;
a navigation system configured to provide second data associated with at least one event on a road on which the vehicle is traveling, wherein the at least one event comprises at least one of a speed limit section on the road, a speed bump on the road, a traffic congestion section on the road, or a curvature of the road;
a driving control circuit configured to control autonomous driving of the vehicle; and
a processor circuit configured to:
obtain, via the sensor, the first data associated with the at least one object in the surrounding environment of the vehicle,
obtain, via the navigation system, the second data associated with the at least one event on the road on which the vehicle is traveling,
output a signal indicating a target speed of the vehicle, wherein the target speed is determined based on the first data and the second data such that the target speed reduces repeated acceleration or deceleration of the vehicle, and
control, via the driving control circuit and based on the signal, autonomous driving of the vehicle.

18. The vehicle of claim 17, wherein the processor circuit is configured to determine the target speed as a lesser of:
a first speed determined based on the first data, and
a second speed determined based on the second data.

19. The vehicle of claim 17, wherein the processor circuit is configured to, based on deceleration events occurring one after another within a predetermined distance or time, determine the target speed to maintain a current decelerated state without an intermediate acceleration.

20. The vehicle of claim 17, wherein the processor circuit is configured to:
based on a congestion state of a rear section of the vehicle detected from the first data, adjust a rate at which the vehicle accelerates toward the target speed,
output a second signal indicating a target lane for the vehicle, wherein the target lane is determined based on the first data and the second data such that the target lane reduces repeated acceleration or deceleration of the vehicle, and
control the autonomous driving of the vehicle further based on the second signal
